(19) United States
(12) Patent Application Publication
(10) Pub. No.: US 2007/0239509 A1
(43) Pub. Date: Oct. 11, 2007

(54) Method, system, and program product for scheduling events

(75) Inventors: David L. Kaminsky, Chapel Hill, NC (US); David M. Ogle, Cary, NC (US)

Correspondence Address: HOFFMAN WARNICK & DALESSANDRO LLC, 75 STATE ST, 14TH FLOOR, ALBANY, NY, 12207, US

(73) Assignee: International Business Machines Corporation, Armonk, NY (US)

(21) Appl. No.: 11/393,586

(22) Filed: Mar. 30, 2006

(51) Int. Cl. G06F 9/46

(52) U.S. Cl. 705/9

(57) ABSTRACT

The invention provides a method, system, and program product for scheduling a plurality of events. In one embodiment, the invention includes scheduling a first event of a plurality of events; scheduling a second event of the plurality of events as dependent upon the first event of the plurality of events; and automatically rescheduling the second event to maintain the dependency of the second event on the first event, in the case that the scheduling of the first event is changed.

### BACKGROUND OF THE INVENTION

1. Technical Field

The invention relates generally to the scheduling of events, and more particularly, to the dependent calendaring and scheduling of an event based on the acceptance or rejection of an invitation to the event.

2. Background Art

Known calendaring and scheduling systems provide calendars of events, such as meetings, and allow a user to send an invitation to such an event to others. Typically, an invitee is given the choice of accepting, rejecting, or ignoring the invitation. If an invitee chooses to accept the invitation, the event is added to the invitee's calendar, along with whatever related information may be necessary or desired (e.g., date, time, duration, location, other invitees, etc.).

Many known systems will warn an invitee of a conflict between an event the invitee has chosen to accept and an event already in the invitee's calendar. The invitee may then choose to reject the invitation or alter his/her existing calendar so that no conflict exists. In the case that the invitee chooses to reject the invitation, the system typically will send a response to the sender and/or other recipients of the invitation informing them of the invitee's rejection of the invitation.

Occasionally, however, an invitee may wish to accept an invitation to an event that he/she has already rejected. This may occur, for example, if a previously scheduled event, which initially conflicted with the invitation event, is cancelled or rescheduled, thus eliminating the conflict with the invitation event. In most known systems, there is no way to accept an already-rejected invitation. In such a case, the invitee may ask the sender of the invitation to re-invite the invitee, at which time the invitee may choose to accept the invitation and add the event to his/her calendar. The difficulties with such systems are many. First, the invitee must accurately remember the relevant information regarding the rejected invitation, including the invitation's sender and the date, time, and location of the event. Second, the invitee must assume that the event parameters (i.e., date, time, location) have not changed since the original invitation was sent. Typically, only those invitees who accept an invitation to an event are informed of changes in the event's parameters. Thus, while an invitee who has previously rejected an invitation to an event may now wish to accept that invitation, the event may have subsequently been cancelled or changes in the event's parameters may create other conflicts with events already scheduled in the invitee's calendar. The invitee would have no way of knowing of these changes, however, until he/she contacts the sender of the original invitation and requests that he/she be sent another invitation to the event.

A few calendaring and scheduling systems retain a record of rejected invitations, but do not provide a user with a reminder that the invitation has been rejected and do not include information regarding the rejected event in a user interface. That is, these calendaring and scheduling systems do not allow a user to view rejected events in the context of other events in his/her calendar. As such, these systems do not allow a user to conditionally reject an invitation to an event and then, upon a change in a previously-conflicting scheduled event, for example, decide to accept the previously-rejected invitation and schedule the event.

In addition, known calendaring and scheduling systems do not take into consideration the possible dependency of one scheduled event upon another scheduled event. As such, a change in the schedule of one event will not be reflected in the schedule of any event dependent upon it. This can lead to the maintenance of dependent events that become irrelevant or ineffective upon the rescheduling or canceling of the event(s) upon which they depend.

To this extent, a need exists for a method and system that does not suffer from the deficiencies of known methods and systems described above.

### SUMMARY OF THE INVENTION

The invention provides a method, system, and program product for scheduling a plurality of events. In one embodiment, the invention includes scheduling a first event of a plurality of events; scheduling a second event of the plurality of events as dependent upon the first event of the plurality of events; and automatically rescheduling the second event to maintain the dependency of the second event on the first event, in the case that the scheduling of the first event is changed.

A first aspect of the invention provides a computer-implemented method for scheduling a plurality of events, the method comprising: scheduling a first event of a plurality of events; and scheduling a second event of the plurality of events as dependent upon the first event of the plurality of events.

A second aspect of the invention provides a system for scheduling a plurality of events, the system comprising: a system for scheduling a first event of a plurality of events; and a system for scheduling a second event of the plurality of events as dependent upon the first event of the plurality of events.

A third aspect of the invention provides a program product stored on a computer-readable medium, which, when executed, schedules a plurality of events, the program product comprising: program code for scheduling a first event of a plurality of events; and program code for scheduling a second event of the plurality of events as dependent upon the first event of the plurality of events.

A fourth aspect of the invention provides a method for deploying an application for scheduling a plurality of events, comprising: providing a computer infrastructure being operable to: schedule a first event of a plurality of events; and schedule a second event of the plurality of events as dependent upon the first event of the plurality of events.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIGS. 1-5 show various views of an illustrative calendaring and scheduling system graphical user interface (GUI) according to the invention.

FIG. 6 shows a flow diagram of an illustrative method according to the invention.

FIG. 7 shows a flow diagram of an alternative illustrative method according to the invention.

FIG. 8 shows a block diagram of an illustrative system according to the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION

As indicated above, the invention provides a method, system, and program product for scheduling a plurality of events.

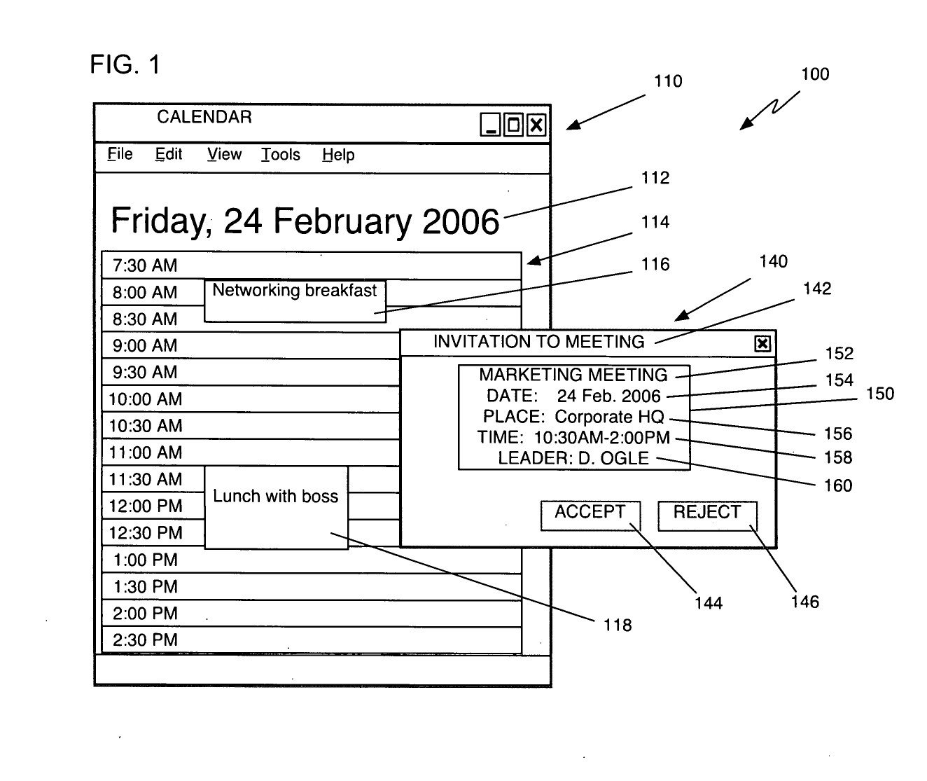

FIGS. 1-5 show various views of an illustrative calendaring and scheduling system graphical user interface (GUI) according to the invention. In FIG. 1, GUI 100 includes a calendar window 110 and an invitation window 140. Calendar window 110 is shown as a single-day calendar comprising a date field 112 and a schedule section 114. Previously-scheduled events 116,118 are shown within schedule section 114.

Invitation window 140 is shown as a “pop-up” window, although any number of methods of displaying or informing a user of an invitation received may be used. Invitation window 140 includes an identifier 142, an event information section 150, an accept button 144, and a reject button 146. Event information section 150 includes an event name 152, an event date 154, an event location 156, an event time 158, and the name of an event leader 160. The information shown in event information section 150 is merely illustrative of information typically relevant to an invitee's decision whether to accept or reject an invitation to an event.

Additional or less information may be provided in event information section 150. For example, an invitee may choose to tentatively accept an invitation to an event. In such a case, the event may be added to the invitee's calendar and the invitee will be reminded of its presence and notified of any changes in its status. However, its presence in the calendar would not preclude the invitee from scheduling another event that temporally overlaps the tentatively-accepted event. Similarly, the tentatively-accepted event will be added to the invitee's calendar even if it conflicts with an existing scheduled event. In one embodiment, the information included in event information section 150 may be user-defined.

Still referring to FIG. 1, it can be seen that the event date 154 and event time 158 conflict with scheduled event 118. Accordingly, a user may choose to reject the invitation described in invitation window 140 by selecting the reject button 146. In such a case, a message may be sent to the sender and/or other recipients of the invitation informing them that the invitee has rejected the invitation to the event. Alternatively, as noted above, a user may choose to tentatively accept the invitation, in which case the tentatively-accepted event will be added to the user's calendar, even though it is currently in conflict with scheduled event 118. In the event that scheduled event 118 is cancelled or rescheduled to a time that no longer conflicts with the tentatively-accepted event, a user may choose to fully (i.e., non-tentatively) accept the event.

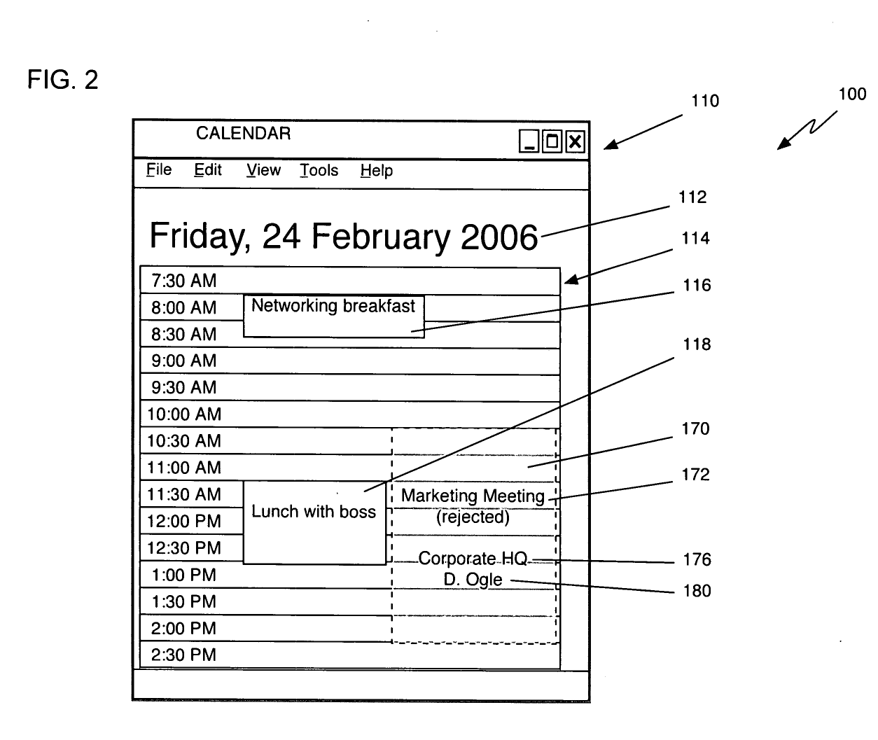

Referring now to FIG. 2, GUI 100 is shown following the invitee's rejection of the invitation in invitation window 140 (FIG. 1). A rejected event reminder 170 has been placed in the invitee's calendar. As can be seen in FIG. 2, rejected event reminder 170 temporally overlaps with scheduled event 118. This is useful, for example, in reminding a user why he/she chose to reject the invitation to the event. Rejected event reminder 170 is shown comprising a rejected event name 172, a rejected event location 176, and the name of the rejected event's leader 180. Additional or less information may be provided in rejected event reminder 170. In one embodiment, the information included in rejected event reminder 170 may be user-defined.

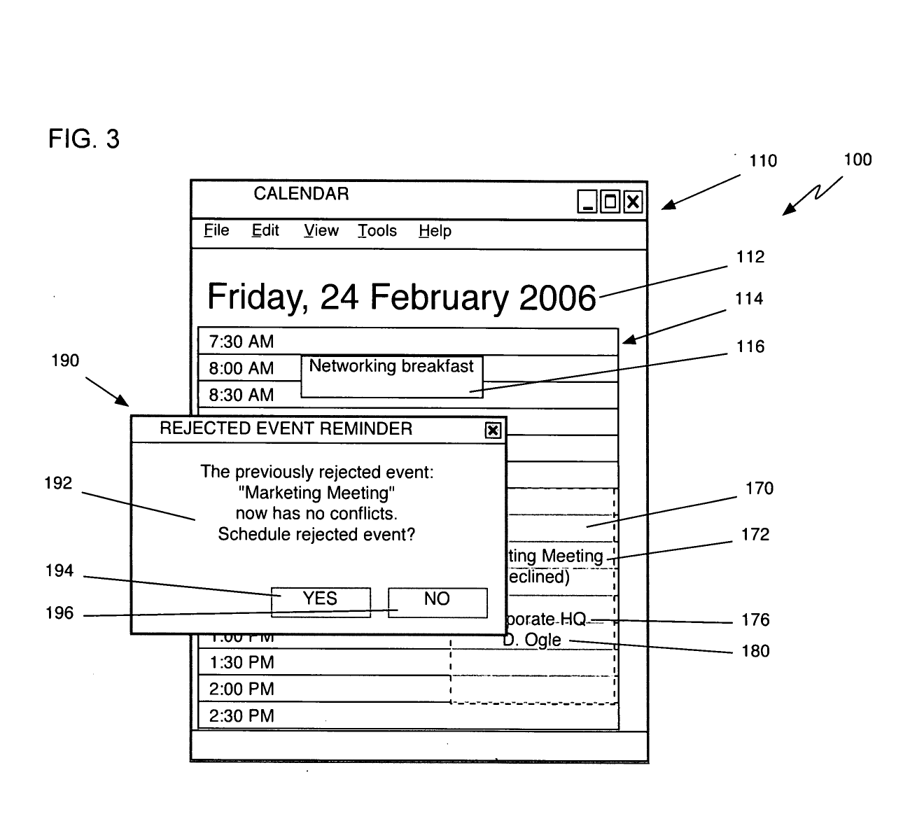

In FIG. 3, GUI 100 is shown following the cancellation of scheduled event 118 (FIG. 2). An inform window 190 is displayed with a message 192 informing the user that there are no longer any scheduling conflicts with the event of the previously-rejected invitation and asking the user if he/she would like to schedule the previously-rejected event. The user may choose to schedule the event or not schedule the event by selecting the Yes button 194 or No button 196, respectively. In the case that the user chooses to schedule the event, a message may be sent to the sender and/or other recipients of the previously-rejected invitation informing them that the invitee has scheduled the event. Such a message may include, for example, an electronic mail message and/or an instant message.

Optionally, a system according to the invention may provide an inform window, such as inform window 190, reminding the user that a previously-rejected event is upcoming, even if there has been no change to an otherwise conflicting scheduled event (e.g., scheduled event 118 of FIG. 2). Such an embodiment may be useful, for example, when a user has delegated attendance at the rejected event to another, such as a co-worker or subordinate. In such a case, the user remains informed of the upcoming event and may choose to follow up with the individual to whom the rejected event was delegated.

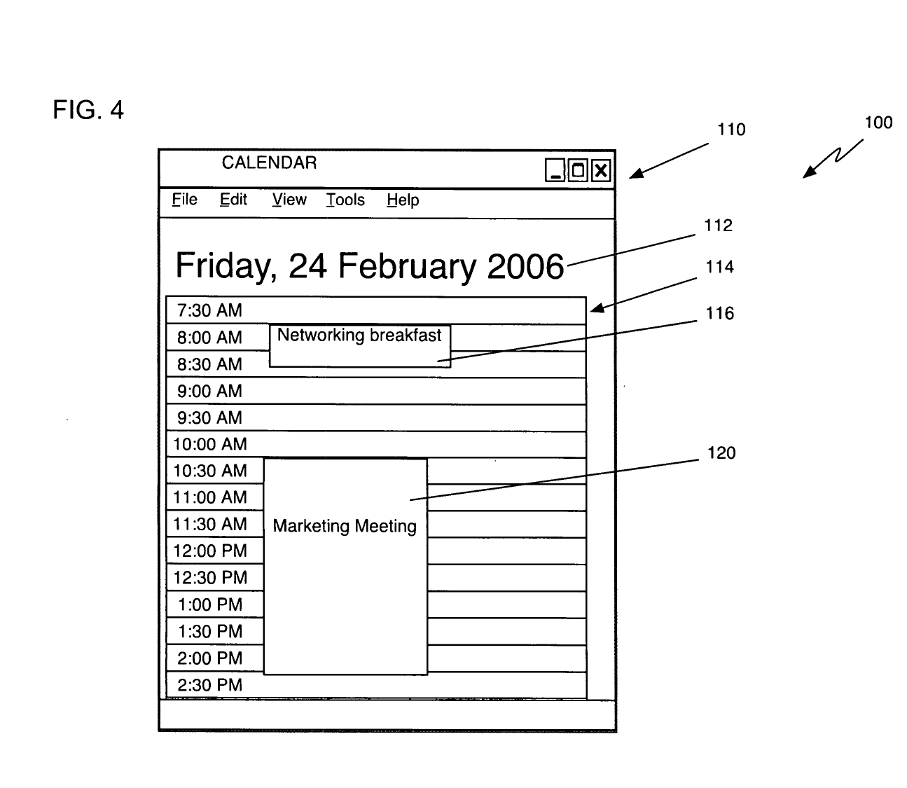

Referring now to FIG. 4, GUI 100 is shown following the scheduling of the previously-rejected event, which is now displayed within schedule section 114 as a scheduled event 120.

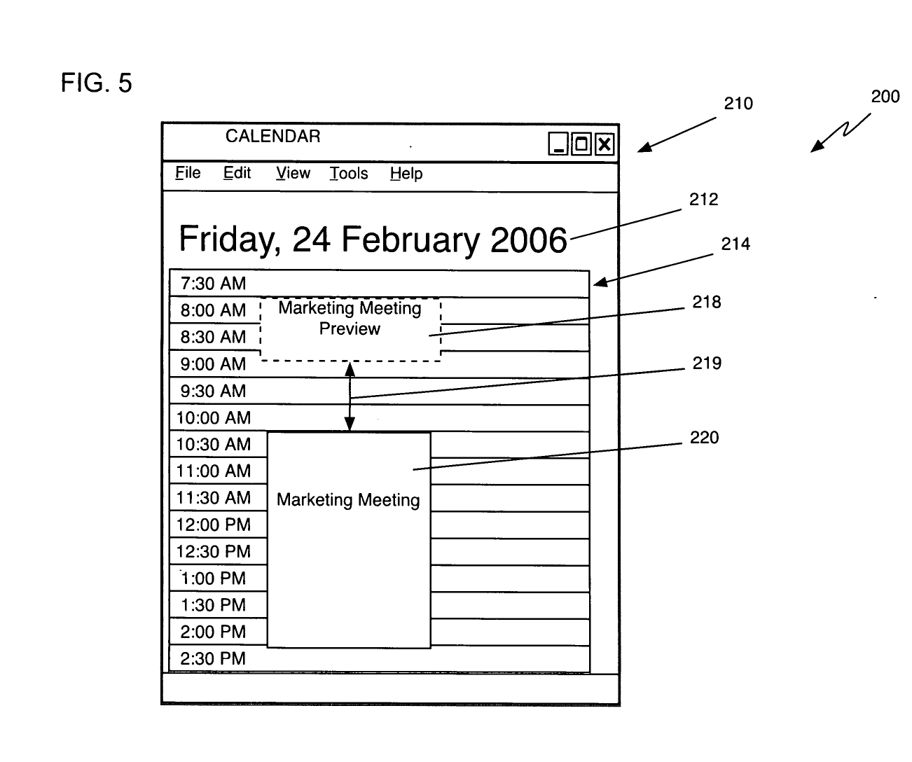

In FIG. 5, GUI 200 shows another aspect of the invention, wherein one or more scheduled events 218 is made dependent 219 upon another scheduled event 220. Such dependencies may be useful, for example, where one event necessarily must occur before, after, or at the same time as another event. For example, as shown in FIG. 5, the “Marketing Meeting Preview” event 218, as a preview, must occur before the “Marketing Meeting” 220. The “Marketing Meeting Preview” may, for example, comprise a strategy session among a number of participants in the later “Marketing Meeting.” By making “Marketing Meeting Preview” 218 dependent 219 upon “Marketing Meeting” 220, the user will be alerted in the event that “Marketing Meeting” 220 is cancelled or rescheduled to a time when it no longer occurs after “Marketing Meeting Preview” 218. Similarly, the user will be alerted in the event that the user or another invitee attempts to reschedule “Marketing Meeting Preview” 218 to a time when it no longer occurs before “Marketing Meeting” 220. In either case, the user may be permitted to reschedule either or both of the scheduled events such that the dependency is maintained. Alternatively, a calendaring and scheduling system according to the invention may automatically reschedule either or both scheduled events to maintain the dependency.

Any number of alternative dependencies among scheduled events may be made. For example, a first scheduled event may be made dependent upon a second scheduled event such that the first event must occur a predetermined number of minutes, hours, days, weeks, etc. before or after the second scheduled event. As such, the first or second scheduled event may be automatically rescheduled in the case that the other scheduled event is rescheduled.

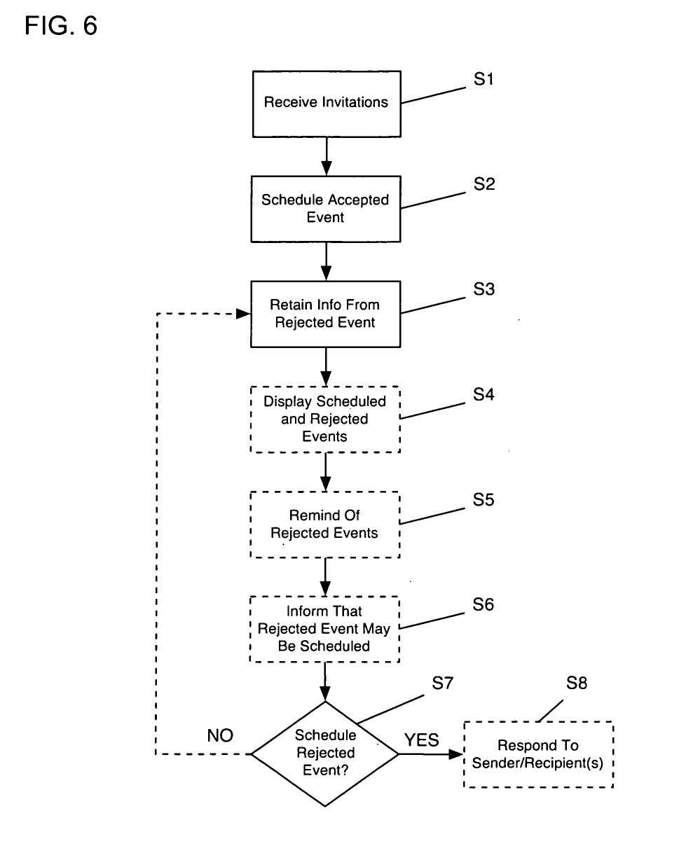

FIG. 6 shows a block diagram of an illustrative method according to the invention. At step S1, a system according to the invention receives one or more invitations to one or more events. At step S2, any events accepted by a user are scheduled in the user's calendar. At step S3, which may occur before step S2, information related to any events rejected by the user are retained by the system. At optional step S4, both scheduled and unscheduled events are displayed to the user in, for example, a GUI, such as that shown in FIGS. 1-5. At optional step S5, the user may be reminded of one or more rejected events. As described above, this may be useful in the case that attendance at one or more rejected events have been delegated to another. At optional step S6, the user is informed that a rejected event may be scheduled in the case, for example, that a previously-conflicting scheduled event has been cancelled, rescheduled, or rejected and now no longer conflicts with the rejected event. At step S7, the user is permitted to decide whether to schedule the previously-rejected event. If the previously-rejected event is scheduled (i.e., “YES” at step S7), a response may be sent to the sender and/or other recipients of the original invitation at step S8, informing them that the user has scheduled the event. If the previously-rejected event is not scheduled (i.e., “NO” at step S7), steps S3 through S7 may optionally be repeated.

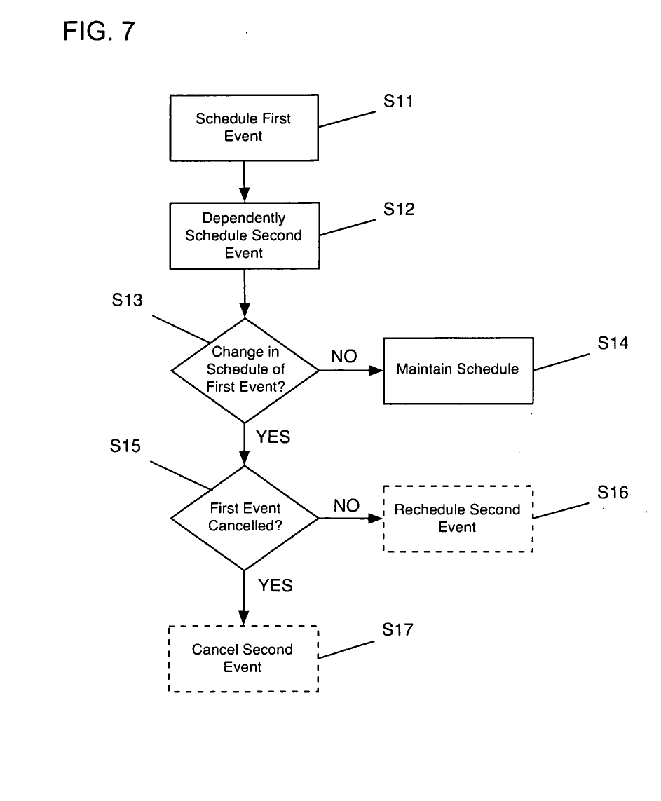

FIG. 7 shows a flow diagram of an alternative method according to the invention. The method of FIG. 7 may be employed where, for example, a user wishes to maintain dependencies between two or more scheduled events, as described above with respect to FIG. 5. First, at step S11, a first event is scheduled. At step S12, a second event is scheduled dependent upon the first event scheduled at step S11. At step S13, it is determined whether the schedule of the first event has changed (e.g., the event's date, time, place, duration, etc.). If the schedule of the first event has not changed (i.e., No at step S13), the schedules of each of the first event and the second event are maintained at step S14, as well as the dependency of the second event upon the first event. If the scheduling of the first event has changed (i.e., Yes at step S13), it is determined at step S15 whether the first event has been cancelled. If not (i.e., No at step S15), the second event may optionally be rescheduled to maintain its dependency upon the first event at step S16. Such rescheduling may be automatic or upon the input of a user. If the first event has been cancelled (i.e., Yes at step S15), the second event may optionally be cancelled at step S17. Such cancelling may be automatic or upon the input or confirmation of a user.

While the illustrative method of FIG. 7 includes only two events, it must be recognized that any number of events and any number of dependencies among events may be scheduled and maintained using the method shown in FIG. 7. For example, an event may be made dependent upon more than one scheduled event, more than one event may be made dependent upon a single scheduled event, an event may be made dependent upon another dependent event, or any combination thereof.

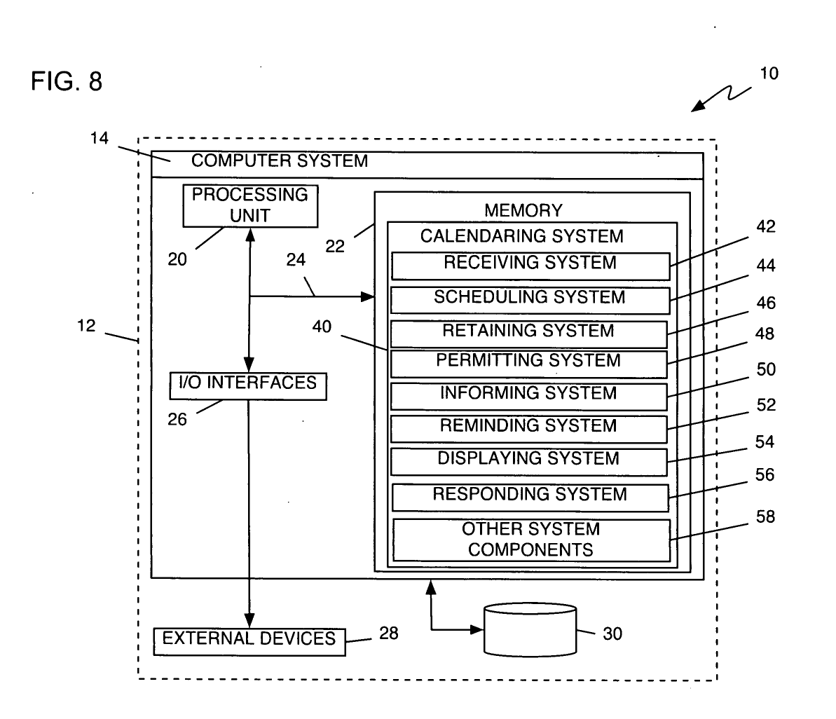

FIG. 8 shows an illustrative system 10 for scheduling a plurality of events. To this extent, system 10 includes a computer infrastructure 12 that can perform the various process steps described herein for scheduling a plurality of events. In particular, computer infrastructure 12 is shown including a computer system 14 that comprises a calendaring system 40, which enables computer system 14 to schedule a plurality of events by performing the process steps of the invention.

Computer system 14 is shown including a processing unit 20, a memory 22, an input/output (I/O) interface 26, and a bus 24. Further, computer system 14 is shown in communication with an external device 28 and a storage system 30. As is known in the art, in general, processing unit 20 executes computer program code, such as calendaring system 40, that is stored in memory 22 and/or storage system 30. While executing computer program code, processing unit 20 can read and/or write data from/to memory 22, storage system 30, and/or I/O interface 26. Bus 24 provides a communication link between each of the components in computer system 14. External devices 28 can comprise any device that enables a user (not shown) to interact with computer system 14 or any device that enables computer system 14 to communicate with one or more other computer systems.

In any event, computer system 14 can comprise any general purpose computing article of manufacture capable of executing computer program code installed by a user (e.g., a personal computer, server, handheld device, etc.). However, it is understood that computer system 14 and calendaring system 40 are only representative of various possible computer systems that may perform the various process steps of the invention. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 12 is only illustrative of various types of computer infrastructures for implementing the invention. For example, in one embodiment, computer infrastructure 12 comprises two or more computer systems (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computer systems may utilize any combination of various types of transmission techniques.

As previously mentioned, calendaring system 40 enables computer system 14 to schedule a plurality of events. To this extent, calendaring system 40 is shown including a receiving system 42, a scheduling system 44, a retaining system 46, a permitting system 48, an informing system 50, a reminding system 52, a displaying system 54, and a responding system 56. Operation of each of these systems is discussed above. Calendaring system 40 may further include other system components 58 to provide additional or improved functionality to calendaring system 40. It is understood that some of the various systems shown in FIG. 8 can be implemented independently, combined, and/or stored in memory for one or more separate computer systems 14 that communicate over a network. Further, it is understood that some of the systems and/or functionality may not be implemented, or additional systems and/or functionality may be included as part of system 10.

While shown and described herein as a method and system for scheduling a plurality of events, it is understood that the invention further provides various alternative embodiments. For example, in one embodiment, the invention provides a computer-readable medium that includes computer program code to enable a computer infrastructure to schedule a plurality of events. To this extent, the computer-readable medium includes program code, such as calendaring system 40, that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computer system, such as memory 22 and/or storage system 30 (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider could offer to schedule a plurality of events as described above. In this case, the service provider can create, maintain, support, etc., a computer infrastructure, such as computer infrastructure 12, that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of generating a system for scheduling a plurality of events. In this case, a computer infrastructure, such as computer infrastructure 12, can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computer system, such as computer system 14, from a computer-readable medium; (2) adding one or more computer systems to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computer system having an information processing capability to perform a particular function either directly or after either or both of the following: (a) conversion to another language, code or notation; and (b) reproduction in a different material form. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A computer-implemented method for scheduling a plurality of events, the method comprising:
scheduling a first event of a plurality of events; and
scheduling a second event of the plurality of events as dependent upon the first event of the plurality of events.

2. The method of claim 1, further comprising:
reminding a user of the dependency of the second event upon the first event in the case that the scheduling of the first event is changed.

3. The method of claim 1, further comprising:
rescheduling the second event to maintain the dependency of the second event on the first event, in the case that the scheduling of the first event is changed.

4. The method of claim 3, wherein the rescheduling is automatic.

5. The method of claim 3, further comprising:
informing a user that the second event has been rescheduled.

6. The method of claim 5, further comprising:
notifying at least one invitee other than the user that the second event has been rescheduled.

7. The method of claim 1, further comprising:
canceling the second event in the case that the first event is cancelled.

8. The method of claim 7, wherein the canceling is automatic.

9. The method of claim 8, further comprising:
informing a user that the second event has been cancelled.

10. The method of claim 9, further comprising:
notifying at least one invitee other than the user that the second event has been cancelled.

11. The method of claim 1, further comprising:
receiving an invitation to at least one of the first event and the second event.

12. The method of claim 11, wherein at least one of the first event and the second event is tentatively accepted by a user.

13. A system for scheduling a plurality of events, the system comprising:
a system for scheduling a first event of a plurality of events; and
a system for scheduling a second event of the plurality of events as dependent upon the first event of the plurality of events.

14. The system of claim 13, further comprising:
a system for rescheduling the second event to maintain the dependency of the second event on the first event, in the case that the scheduling of the first event is changed.

15. The system of claim 14, further comprising:
a system for notifying at least one invitee other than the user that the second event has been rescheduled.

16. The system of claim 13, further comprising:
a system for canceling the second event in the case that the first event is cancelled.

17. The system of claim 16, further comprising:
a system for notifying at least one invitee other than the user that the second event has been cancelled.

18. A program product stored on a computer-readable medium, which, when executed, schedules a plurality of events, the program product comprising:
program code for scheduling a first event of a plurality of events; and
program code for scheduling a second event of the plurality of events as dependent upon the first event of the plurality of events.

19. The program product of claim 18, further comprising:
program code for rescheduling the second event to maintain the dependency of the second event on the first event, in the case that the scheduling of the first event is changed.

20. A method for deploying an application for scheduling a plurality of events, comprising:
providing a computer infrastructure being operable to:
schedule a first event of a plurality of events; and
schedule a second event of the plurality of events as dependent upon the first event of the plurality of events.
